(19) United States
(12) Patent Application Publication
(10) Pub. No.: US 2012/0200084 A1
(43) Pub. Date: Aug. 9, 2012

(54) UNDERWATER POWER GENERATOR

(75) Inventors: Drew Blaxland, Singapore (SG); John Keir, Singapore (SG)

(73) Assignee: ATLANTIS RESOURCES CORPORATION PTE LIMITED, Singapore (SG)

(21) Appl. No.: 13/502,591

(22) PCT Filed: Oct. 26, 2010
(86) PCT No.: PCT/AU10/01426

§ 371 Date: Apr. 18, 2012

(30) Foreign Application Priority Data
Oct. 26, 2009 (AU) 2009905226
Oct. 26, 2009 (AU) 2009905227

(51) Int. Cl. F03B 13/10; F03B 3/12

(52) U.S. Cl. 290/43; 416/223 R

(57) ABSTRACT

An underwater power generator (10) comprises a support structure (14) including a pylon (22) having a male boss (24) at an upper end of the pylon (22). A generation unit (12) has a housing (15) and a blade set (16). A female socket (28) is provided on the generation unit (12) and is configured to receive the male boss (24). A rotation unit (30) comprises a motorised pinion (56) mounted on an upper section (50) and a fixed ring gear (58) mounted on a lower section (52), wherein operation of the motorised pinion (56) rotates the upper section (50) relative to the lower section (52) about a yaw axis. A seal arrangement (60) is provided between the upper and lower sections (50, 52) to inhibit the ingress of water into the rotation unit (30).

### FIELD OF THE INVENTION

The present invention relates generally to underwater power generators for generating power from water flows, such as marine currents and tidal or river flows.

### BACKGROUND OF THE INVENTION

Known underwater power generators harness the power of marine currents and tidal flows to drive the rotation of turbine blades, which in turn drives a generator to generate power.

Optimum locations for operation of underwater power, generators with suitable marine current and tidal flows are often less than optimum environments for deployment of the underwater power generators. Corrosive environments, exposure to marine life, marine growth, remote locations and rugged floor terrain all create significant challenges to successful deployment of underwater power generators.

Many locations have oscillating currents that reverse direction with the change of tide and other locations have currents that vary in direction. As underwater power generators typically have a single or narrow range of optimal water flow direction, in order to maximise the power generated in a given location, it is often desirable that the underwater power generator be rotatable in order to readdress a change in water direction. For tidal locations, this typically requires rotation by 180°.

However, the complex machinery required to rotate an underwater power generator often fouls readily in the hostile underwater environments. This results in the necessity for frequent maintenance, which is expensive and difficult as the power generator typically has to be raised above water for maintenance operations.

Accurate deployment of underwater power generators is often difficult due to rugged floor terrain, wave movements when deploying from floating barges and underwater currents. Even slight misalignment of an underwater power generator relative to the water current direction or horizontal misalignment can be detrimental to efficiency and effective operation of the underwater power generator.

In order to maximise power output from slow flowing currents (of the order of 5 nautical miles per hour), efficient blade design is also important.

### OBJECT OF THE INVENTION

It is an object of the present invention to substantially overcome or at least ameliorate one or more of the above disadvantages, or to provide a useful alternative.

### SUMMARY OF THE INVENTION

In a first aspect, the present invention provides an underwater power generation apparatus adapted to generate power from flowing water, the apparatus comprising:
a support structure including a pylon having a male boss at an upper end of the pylon;
a generation unit having a housing and a blade set mounted for rotation relative to the housing, the blade set being adapted to rotate when the power generation apparatus is submersed in the flowing water;
a female socket provided on the generation unit, the female socket being configured to receive the male boss; and
a rotation unit arranged between an upper section of the power generation apparatus and a lower section of the power generation apparatus, the rotation unit comprising a motorised pinion mounted on the upper section and a fixed ring gear mounted on the lower section, wherein the pinion is in meshed engagement with the ring gear and operation of the motorised pinion rotates the upper section relative to the lower section about a yaw axis.

In a preferred embodiment, the upper section is the housing and the lower section is the female socket. Alternatively, the upper section and the lower section are two parts of the pylon.

Preferably, the power generation apparatus further comprises a tilt unit arranged between the upper section and the lower section, the tilt unit being adapted to adjust tilting about the pitch or roll axes between the upper section and lower section to maintain the generation unit in a level position. Further preferably, the tilt unit is integral with the rotation unit.

In a preferred embodiment, complimentary engagement formations are formed on surfaces of the male boss and female socket to inhibit rotational movement between the male boss and female socket. Preferably, the engagement formations are complimentary splines.

Preferably, the female socket rests unrestrained on the male boss under gravity and is disengageable from the male boss by simply lifting the generation unit.

Optionally, the power generation apparatus further comprises a control system which controls the rotation unit to adjust the orientation of the generation unit in response to a change in a parameter of power generation performance.

In a preferred embodiment, the blade set comprises a plurality of blades and each blade has a chord, as measured from a leading edge of the blade to a trailing edge of the blade, wherein the blade chord increases in length from a blade root to an intermediate point and then decreases in length from the intermediate point to a blade tip and wherein the intermediate point is approximately 30% along the length of the blade from the blade root to the blade tip. Preferably, the blades have a degree of twist along the length of the blade.

Preferably, a sealing arrangement provided between the upper section and the lower section to inhibit the ingress of water into the rotation unit.

In a second aspect, the present invention provides a rotation unit for rotating a generation unit of an underwater power generation apparatus, the rotation unit comprising:
a lower section having a fixed ring gear with a plurality of teeth projecting in a first radial direction and a rib projecting in a second opposite radial direction;
an upper section having a motorised pinion in meshed engagement with the teeth of the ring gear and a bearing groove configured to receive the rib of the ring gear.

In a preferred embodiment, the teeth project inwardly and the rib projects outwardly.

Preferably, the rotation unit further comprises a sealing arrangement, the sealing arrangement comprising:
a channel flange provided on one of the lower and upper sections;
a seal flange provided on the other of the lower and upper sections and having one or more seals provided on a radial surface of the seal flange;
wherein the seal flange is received in the channel flange and the seals engage a surface of the channel flange to inhibit water ingress into the rotation unit.

In a preferred embodiment, the channel flange is provided on the lower section and the seal flange is provided on the upper section.

Preferably, the seals are lip seals.

In a third aspect, the present invention provides a rotation unit for rotating a generation unit of an underwater power generation apparatus, the rotation unit comprising:
a lower section having a downwardly projecting male boss and a ring gear mounted within the lower section;
an upper section having an upwardly projecting male boss and a motorised pinion mounted in the upper section and projecting downwardly into the lower section, wherein the pinion is in meshed engagement with the ring gear; and
a sealing arrangement provided between the upper section and the lower section to inhibit the ingress of water into the rotation unit,
wherein the male bosses of the lower section and upper section are adapted to be received in corresponding female sockets of the power generation apparatus.

### BRIEF DESCRIPTION OF THE DRAWINGS

A preferred embodiment of the invention will now be described by way of specific example with reference to the accompanying drawings, in which:

FIG. 1 depicts an underwater power generator mounted on a pylon;

FIG. 2 depicts an alternate underwater power generator mounted on a pylon;

FIG. 3 depicts a generation unit of an underwater power generator;

FIG. 4 is an elevation view of the generation unit of FIG. 3;

FIG. 5 is a cross-sectional view of the generation unit of FIG. 3;

FIG. 6 is a detailed cross-sectional view of the generation unit of FIG. 5;

FIG. 7 is a cross-sectional view of an alternate generation unit of an underwater power generator;

FIG. 8 is a cross-sectional view of another alternate generation unit of an underwater power generator;

FIG. 9 depicts a rotation unit of a underwater power generator;

FIG. 10 is a sectional view along A-A in FIG. 9;

FIG. 11 is a sectional view along B-B in FIG. 10;

FIG. 12 is a partial sectional view of an alternate rotation unit for an underwater power generator;

FIG. 13 is a schematic representation of a rotation unit at the base of a pylon of an underwater power generator; and

FIG. 14 is a schematic representation of an alternate rotation unit at the base of a pylon of an underwater power generator.

### DETAILED DESCRIPTION OF THE PREFERRED EMBODIMENTS

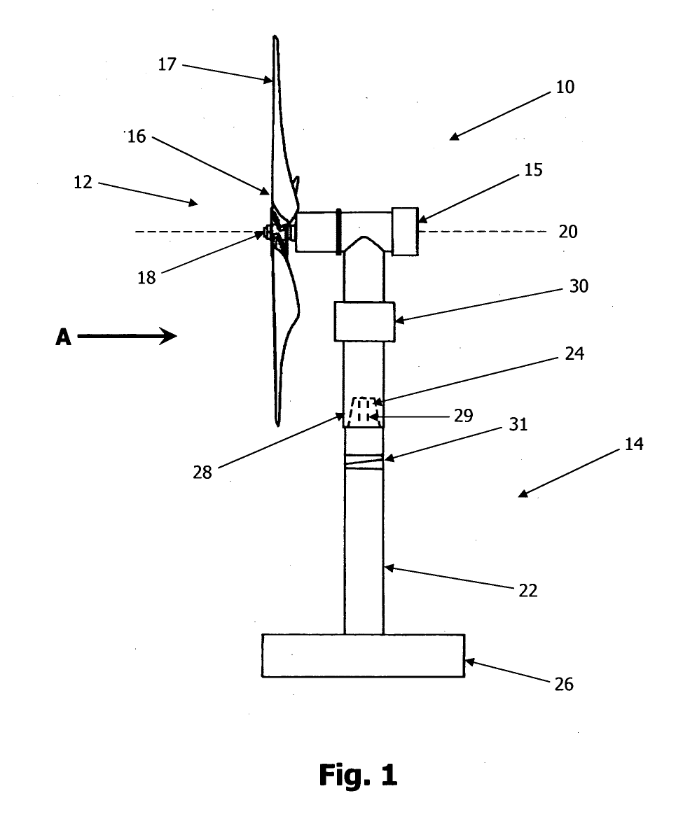

FIG. 1 depicts an underwater power generation apparatus 10, which includes a generation unit 12 and a support structure 14.

The generation unit 12 includes a housing 15 and a rotor or blade set 16, the blade set 16 having three blades 17 mounted on a central rotor hub 18. The blade set 16 is designed to rotate about a horizontal rotation axis 20 in response to a flowing water current generally parallel to the rotation axis 20 in the flow direction A.

The support structure 14 comprises a pylon 22 having a male boss 24 at an upper end and being mounted to a base platform 26 at a lower end. The base platform 26 typically includes recesses for receiving spoil, concrete or other stabilising mass. The base platform 26 and the pylon 22 may be detachable from one another. Alternatively, in some embodiments, the pylon 22 is simply installed directly in the seabed.

The generation unit 12 is provided with a female socket 28 that is adapted to receive the male boss 24. The female socket 28 is designed to be lowered over, and to rest under gravity on, the male boss 24. Splines 29 are provided to prevent rotation of the female socket 28 relative to the male boss 24. No locking mechanism, clamping or other fastening mechanism is required to retain the generation unit 12 on the support structure 14 as gravity holds the generation unit 12 in place. This allows the generation unit 12 to be raised for maintenance simply by lifting the generation unit 12, which disengages the female socket 28 from the male boss 24.

In some embodiments, the female socket 28 includes a mechanical restraint to augment the gravity connection, while still allowing disengagement from the male boss 24 by simply lifting the generation unit 12. This provides an additional factor of safety for occasional impact loads.

The female socket 28 overlaps the male boss 24 when the generation unit 12 is mounted on the pylon 22, with the overlapping section being approximately 2 metres in length.

One advantage of having the male boss 24 on the upper end of the pylon 22 is that the pylon 22 is easier to maintain and will be less likely to become clogged with silt and marine growth than a female socket.

The generation unit 12 is also provided with a yaw rotation unit 30 arranged between the housing 15 and the female socket 28. The rotation unit 30 is adapted to rotate the housing 15 relative to the female socket 28. This allows the housing 15 and blade set 16 to be rotated in order to face the direction of flow of the water current.

A pitch and roll tilt unit 31 is shown disposed at an intermediate position on the pylon 22, which is adapted to allow adjustment of the alignment of the generation unit 12 about pitch and roll axes. Alternatively, the yaw rotation unit 30 may be integral with the pitch and roll tilt unit 31.

In normal operation, all of the aforementioned components on the pylon 22 and generation unit 12 are disposed downstream of the blade set 16.

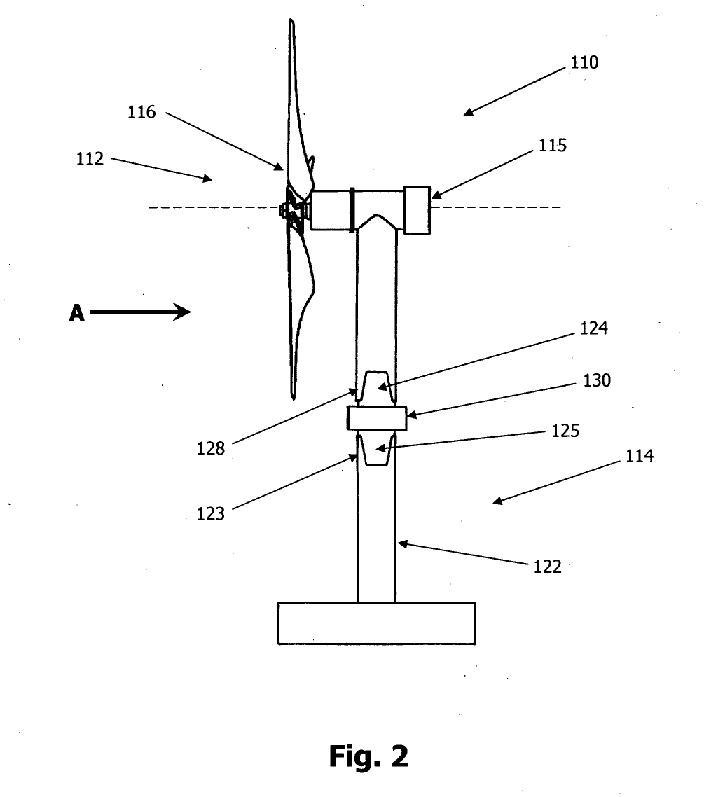

Depicted in FIG. 2 is an alternative embodiment of the power generation apparatus 110, in which the generation unit 112 includes a housing 115, a blade set 116 and a female socket 128. However, the rotation unit 130 is arranged below the female socket 128.

In this alternate embodiment, the rotation unit 130 is provided with an upper male boss 124, which is adapted to receive the female socket 128 lowered over the upper male boss 124 in the same way as the embodiment discussed above with reference to FIG. 1. This allows the generation unit 112 to be deployed and raised for maintenance independently of the rotation unit 130.

The support structure 114 includes a pylon 122 having a female socket 123 at an upper end. The rotation unit 130 is also provided with a lower male boss 125 that is adapted to be received in the female socket 123 of the pylon 122 to mount the rotation unit 130 on the pylon 122.

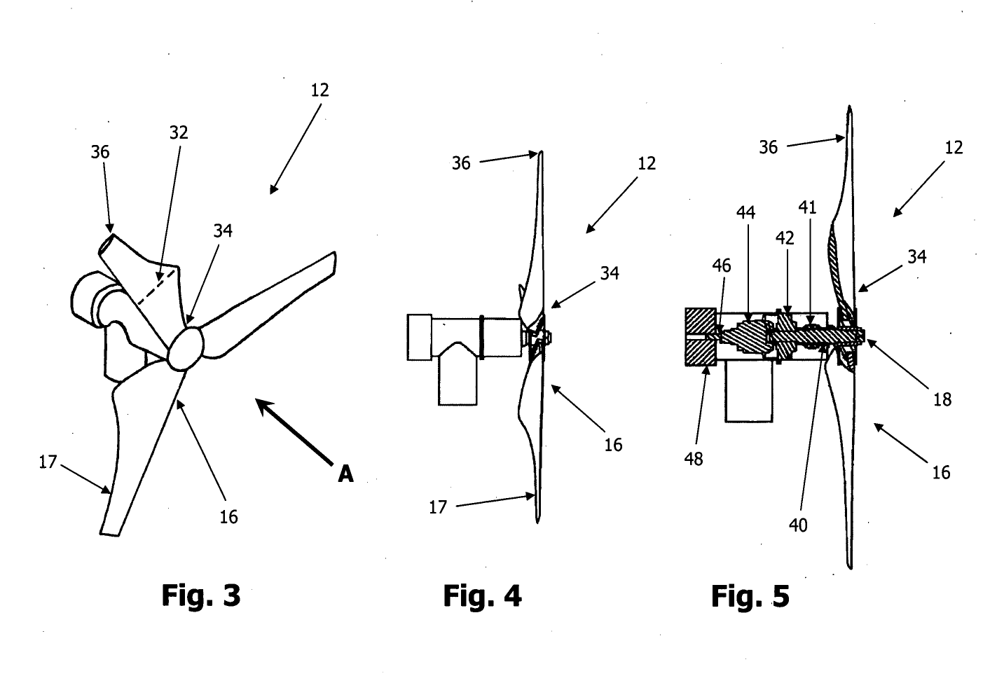

As depicted in FIGS. 3 and 4, the generation unit 12 has a blade set 16 with three blades 17 that are designed to be mono-directional, meaning that they are designed to drive rotation of the blade set 16 in response to water flowing in direction A but not water flowing in the reverse direction. Each blade 17 is designed such that a chord 32 of the blade 17, as measured from the leading edge to trailing edge of the blade 17, varies along the length of the blade 17. In particular, the chord 32 increases in length from a blade root 34 to an intermediate point 36 and then decreases in length towards a blade tip 36. The intermediate point is approximately 30% along the length of the blade 17 from the blade root 34 to the blade tip 36. The blades 17 also have a degree of twist along the length of the blade 17 to improve efficiency of lift.

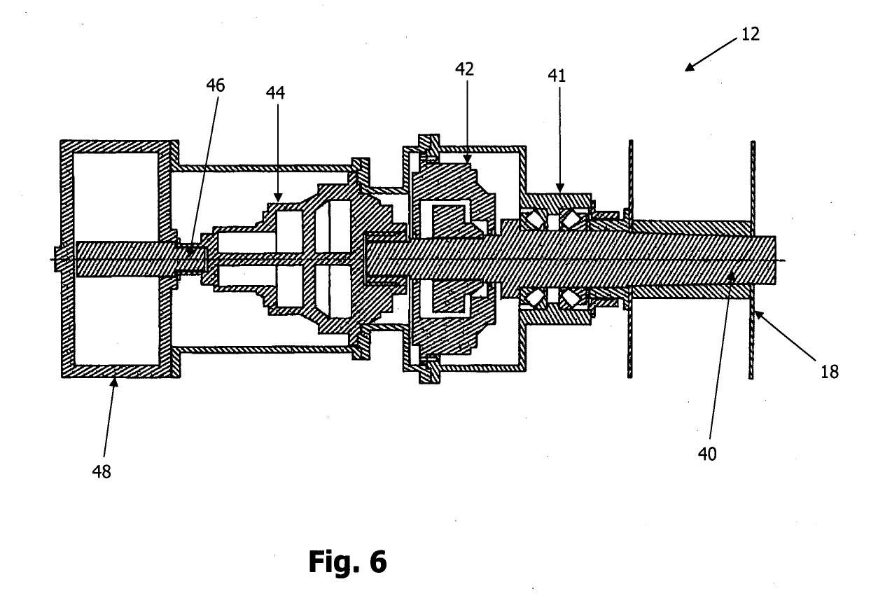

Referring to FIG. 5, and in greater detail in FIG. 6, the generation unit 12 is shown in cross-section. The blade set 16 is mounted via the rotor hub 18 to a rotor shaft 40, which extends through a bearing assembly 41 and a brake assembly 42 to a gearbox 44. A drive shaft 46 extends from the gearbox 44 to drive a generator unit 48.

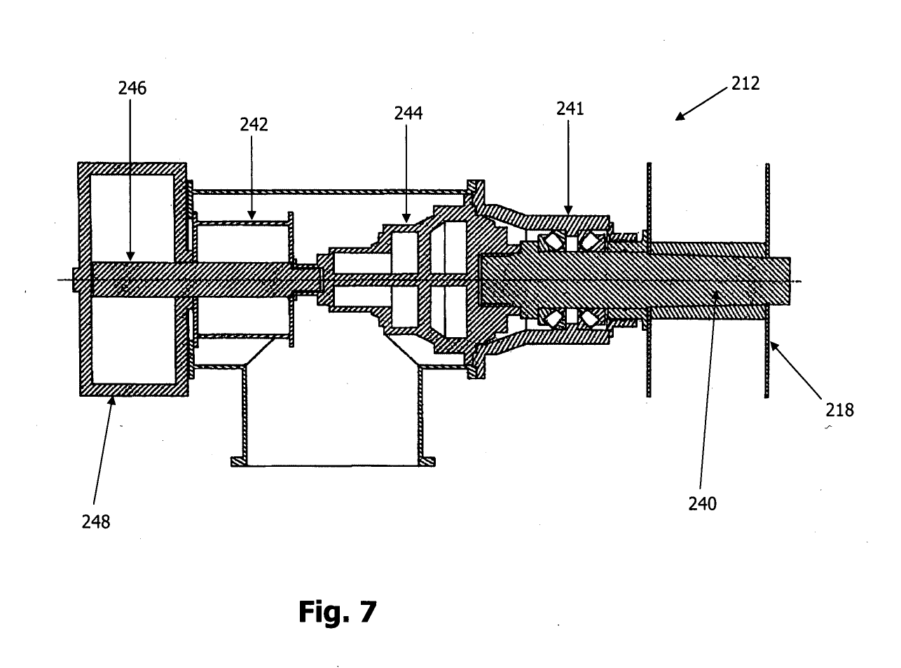

Turning to FIG. 7, and alternative embodiment of the generation unit 212 is depicted, in which a rotor hub 218 is mounted to a rotor shaft 240, which extends through a bearing assembly 241 to a gearbox 244. A drive shaft 246 extends from the gearbox 244 and extends through a brake assembly 242 to drive a generator unit 248. By arranging the brake assembly 242 on the drive shaft 246 rather than the rotor shaft 240, less braking torque is required to stop the blade set.

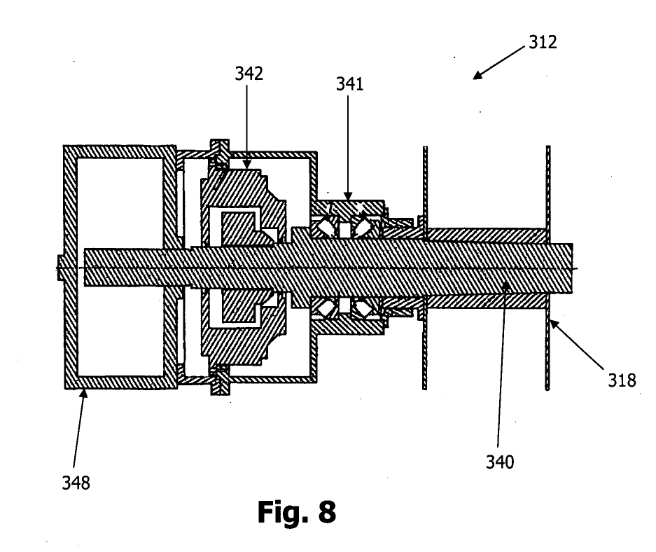

FIG. 8 depicts a direct drive embodiment of the generation unit 312 without a gearbox. A rotor hub 318 is mounted to a rotor shaft 340, which extends through a bearing assembly 341 and a brake assembly 342 to drive a generator unit 348.

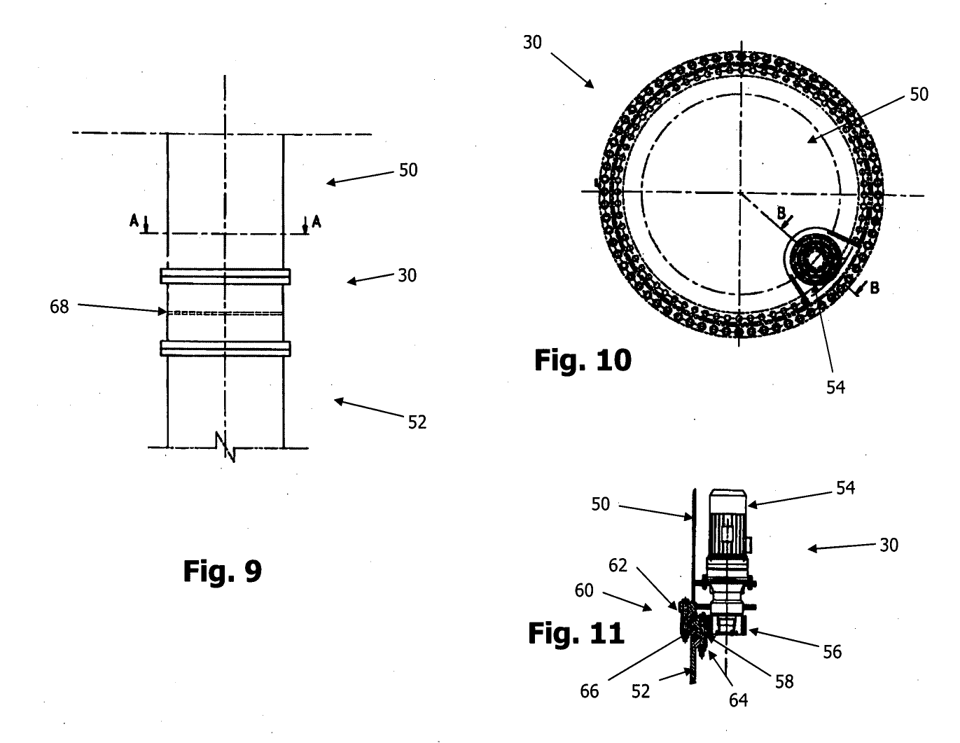

The rotation unit 30 is depicted in greater detail in FIGS. 9 to 11, in which FIG. 10 is a cross section along line A-A in FIG. 9 and FIG. 11 is a cross section along line B-B in FIG. 10. An upper section 50 is mounted by the rotation unit 30 for rotation relative to a lower section 52. A motor 54 is mounted to the upper section 50 and drives a pinion 56. The pinion 56 engages a fixed ring gear 58 mounted on the lower section 52. When driven by the motor 54, the pinion 56 travels around the fixed ring gear 58 causing the upper section 50 to rotate relative to the lower section 52.

A seal arrangement 60 includes an outer flange 62 on the upper section 50, an inner flange 64 on the lower section and seals 66. The outer flange 62 projects downwardly over the inner flange 64, such that the two flanges 62, 64 overlap vertically. A series of seals 66 are arranged in recesses between the inner surface of the outer flange 62 and the outer surface of the inner flange 64. The seal arrangement 60 inhibits the ingress of water between the upper section 50 and the lower section 52.

A diaphragm plate 68 is provided to also further inhibit water ingress to interior areas.

Optionally, flooded friction bearings can be used. In a further optional arrangement, the pinion gear is provided on the outside of the ring gear and the teeth of the ring gear face outwards.

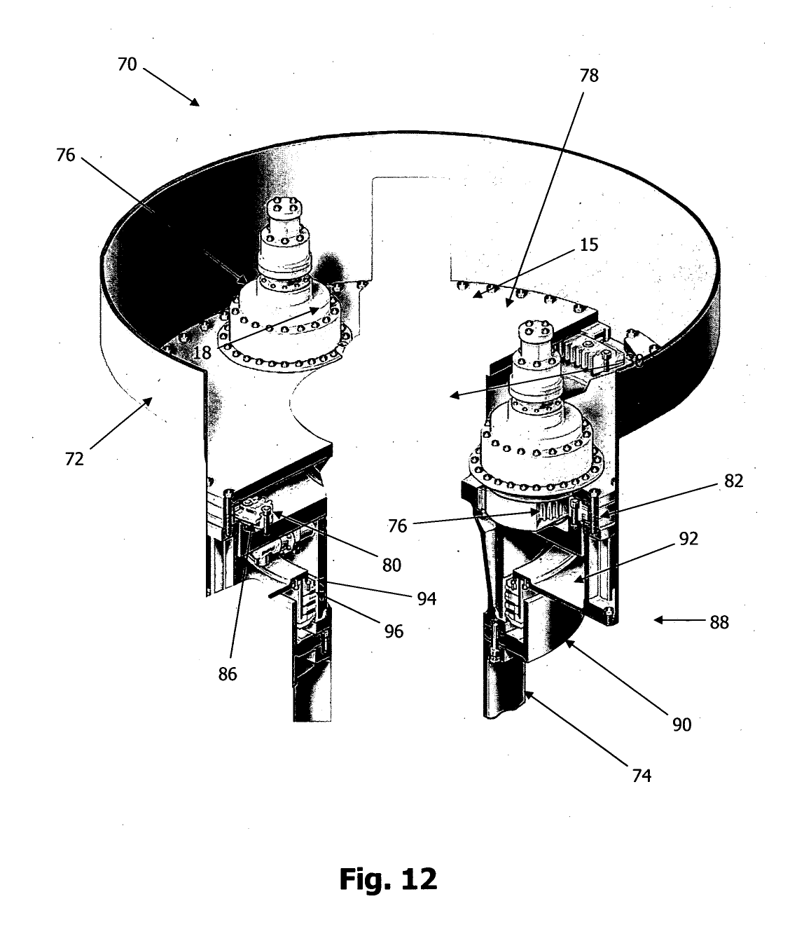

An alternative rotation unit 70 is depicted in FIG. 12 between an upper section 72 and a lower section 74. The rotation unit 70 includes two motorised pinions 76 mounted on a plate 78 of the upper section 72, such that the pinions 76 project below the plate 78. An inwardly facing ring gear 80 is mounted at the top of the lower section 74, encircling, and in meshed engagement with, the pinions 72.

The plate 78 has a downwardly depending bearing flange 82 that projects downwardly from the plate 78, radially outward of the ring gear 80. The bearing flange 82 defines an inwardly facing circular bearing groove that supports a circular rib 86 projecting outwardly from the outer surface of the ring gear 80 and is received in the bearing flange 82.

When the pinions 76 are driven, they travel around the inner circumference of the ring gear 80, forcing the plate 78 to rotate. Movement of the bearing flange 82 around the circular rib 86 allows rotation of the plate 78.

A sealing arrangement 88 includes an outer channel flange 90 provided on the lower section 74 and a seal flange 92 projecting from the upper section 72. The seal flange 92 is received in the channel flange 90 and lip seals 96 on the seal flange 92 seal against an outer surface 94 of the lower section 74. This provides a reliable sealing configuration that inhibits water ingress to the rotation unit 70.

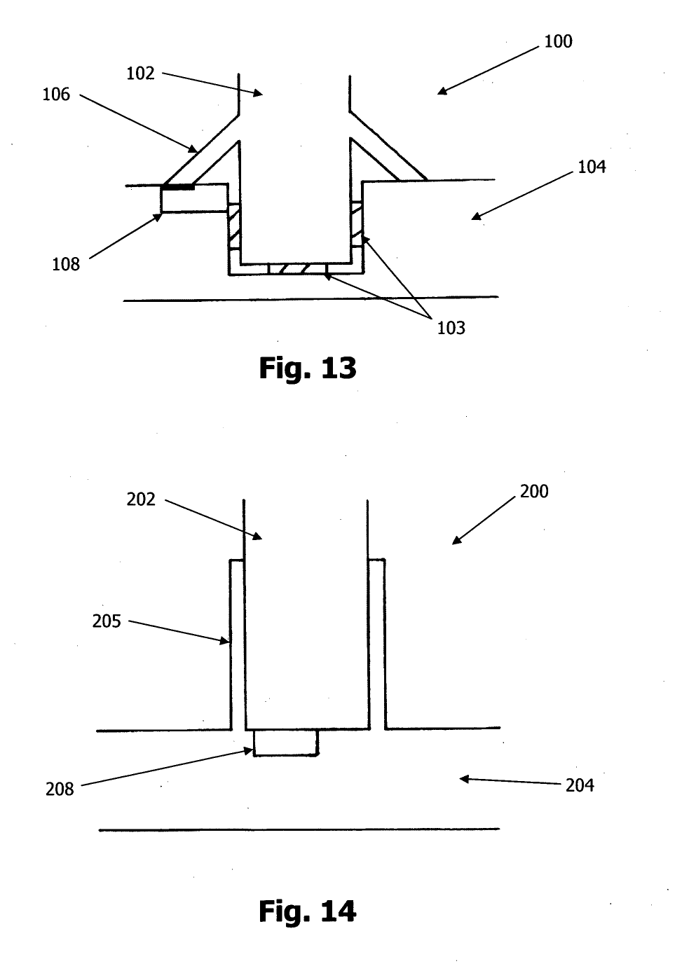

FIG. 13 depicts a base rotation unit 100 in which a pylon 102 is mounted for axial rotation relative to a base platform 104. A skirt 106 depends from the pylon 102 and engages a drive mechanism 108 in the base platform 104 to drive rotation of the pylon 102 relative to the base platform 104. Bearings 103 allow the pylon 102 to rotate relative to the base platform 104.

FIG. 14 depicts an alternative base rotation unit 200 in which a pylon 202 is mounted for rotation relative to a base platform 204 in an upwardly projecting pylon socket 205 provided on the base platform 204. A drive mechanism 208 is provided in the pylon socket 205 to engage and drive rotation of the pylon 202.

Although the invention has been described with reference to specific examples, it will be appreciated by those skilled in the art that the invention may be embodied in many other forms.

1. An underwater power generation apparatus adapted to generate power from flowing water, the apparatus comprising:
a support structure including a pylon having a male boss at an upper end of the pylon;
a generation unit having a housing and a blade set mounted for rotation relative to the housing, the blade set being adapted to rotate when the power generation apparatus is submersed in the flowing water;
a female socket provided on the generation unit, the female socket being configured to receive the male boss;
complementary engagement formations being formed on surfaces of the male boss and female socket to inhibit rotational movement between the male boss and female socket; and
a rotation unit arranged between an upper section of the power generation apparatus and a lower section of the power generation apparatus, the rotation unit comprising a motorised pinion mounted on the upper section and a fixed ring gear mounted on the lower section, wherein the pinion is in meshed engagement with the ring gear and operation of the motorised pinion rotates the upper section relative to the lower section about a yaw axis.

2. The power generation apparatus of claim 1, wherein the upper section is the housing and the lower section is the female socket.

3. The power generation apparatus of claim 1, wherein the upper section and the lower section are two parts of the pylon.

4. The power generation apparatus of claim 1, further comprising a tilt unit arranged between the upper section and the lower section, the tilt unit being adapted to adjust tilting about the pitch or roll axes between the upper section and lower section to maintain the generation unit in a level position.

5. The power generation apparatus of claim 4, wherein the tilt unit is integral with the rotation unit.

6. (canceled)

7. The power generation apparatus of claim 1, wherein the complimentary engagement formations are complimentary splines.

8. The power generation apparatus of claim 1, wherein the female socket rests unrestrained on the male boss under gravity and is disengageable from the male boss by simply lifting the generation unit.

9. The power generation apparatus of claim 1, further comprising a control system which controls the rotation unit to adjust the orientation of the generation unit in response to a change in a parameter of power generation performance.

10. The power generation apparatus of claim 1, wherein the blade set comprises a plurality of blades and each blade has a chord, as measured from a leading edge of the blade to a trailing edge of the blade, wherein the blade chord increases in length from a blade root to an intermediate point and then decreases in length from the intermediate point to a blade tip and wherein the intermediate point is approximately 30% along the length of the blade from the blade root to the blade tip.

11. The power generation apparatus of claim 10, wherein the blades have a degree of twist along the length of the blade.

12. The power generation apparatus of claim 1, wherein a sealing arrangement is provided between the upper section and the lower section to inhibit the ingress of water into the rotation unit.

13. An independent rotation unit for rotating a generation unit of an underwater power generation apparatus on a pylon, the independent rotation unit mountable to the pylon and comprising:
a first section including a fixed ring gear including a plurality of teeth projecting in a first radial direction;
second section rotatable relative to the first section, the second section including a motor and a pinion which is in meshed engagement with the teeth of the fixed ring gear of the first section for independent powered rotation of the second section relative to the first section;
wherein at least one of the first and second sections includes flanges extending therefrom in a direction along the pylon, the one or more flanges overlapping the other of the first and second sections; and
a sealing arrangement which includes a plurality of circumferential seals extending between opposed faces of the flanges to inhibit water ingress to the first and second sections.

14-17. (canceled)

18. A rotation unit for rotating a generation unit of an underwater power generation apparatus, the rotation unit comprising:
a lower section having a downwardly projecting male boss and a ring gear mounted within the lower section;
an upper section having an upwardly projecting male boss and a motorised pinion mounted in the upper section and projecting downwardly into the lower section, wherein the pinion is in meshed engagement with the ring gear; and
a sealing arrangement provided between the upper section and the lower section to inhibit the ingress of water into the rotation unit;
wherein the male bosses of the lower section and upper section are adapted to be received in corresponding female sockets of the power generation apparatus.
